(19) United States
(12) Patent Application Publication
(10) Pub. No.: US 2017/0320065 A1
(43) Pub. Date: Nov. 9, 2017

(54) A LIFTER BAR, METHOD FOR MAKING A LIFTER BAR, METHOD FOR ASSEMBLING A LIFTER BAR AND A GRINDING MILL

(71) Applicant: OUTOTEC (FINLAND) OY, Espoo (FI)

(72) Inventor: Kari LAUERMAA, Jyväskylä (FI)

(21) Appl. No.: 15/517,307

(22) PCT Filed: Oct. 12, 2015
(86) PCT No.: PCT/FI2015/050684

§ 371 Date: Apr. 6, 2017

(30) Foreign Application Priority Data
Oct. 14, 2014 (FI) 20145900

(51) Int. Cl. B02C 17/18

(52) U.S. Cl. CPC B02C 17/1825; B02C 2210/02

(57) ABSTRACT

This relates to a lifter bar, a method for making a lifter bar, a method for assembling a lifter bar and a grinding mill comprising multiple lifter bars. The lifter bar comprises a lifter bar body having a wear surface and comprising polyurethane (PU), a reinforced wearing plate attached to the lifter bar body and forming part of the wear surface. The reinforced wearing plate comprises metal and a wearing surface for forming a part of the wear surface of the lifter bar, and an attachment structure provided to the reinforced wearing plate for attaching the reinforced wearing plate to the lifter bar body. The attachment structure protrudes into the lifter bar body for forming a connection with polyurethane (PU).

### FIELD OF THE TECHNOLOGY

The present invention relates to a lifter bar, and particularly to a lifter bar as defined in the independent claim 1. The present invention relates also to a method for making a lifter bar as defined in the independent claim 22, to a method for assembling a lifter bar as defined in the independent claim 24 and to a grinding mill as defined in the independent claim 27.

### BACKGROUND

Grinding mills are used for processing hard solid material such that large solid material is grinded into smaller pieces. The lifter bars' function is to assist in lifting the solid material that is being processed in the drum as it rotates.

### BRIEF DESCRIPTION

The lifter bar, the method for making a lifter bar, the method for assembling the lifter bar and the grinding mill are characterized by what is stated in the independent claims. The preferred embodiments are disclosed in the dependent claims.

The solid material is crushed in a drum shaped shell mounted for rotation about its central axis in the grinding mill. The axis of the rotatable shell is generally horizontally arranged or slightly inclined towards one end in the grinding mill. The interior of the shell forms a treatment chamber and has a cylindrical wall. The inner surface of the chamber is plated with a lining for protecting the shell because the material to be processed is fed to the treatment chamber and grinding it causes wear in the chamber. The interior wall of the shell is equipped with lifter bars for lifting the material inside the shell along the rotation so that as the shell rotates the lifter bars lift up the solid material along the inside wall of the shell to a point where gravity causes the solid material to fall down inside the shell and by falling down the solid material is crushed. A line of lifter bars extend from one end of the drum to another and they are arranged in a short spacing adjacently along the cylindrical wall of the shell such that there are shell plates arranged between adjacent lifter bars. As compared to the lining the lifter bars protrude more from the shell wall than the lining.

A lifter bar is mountable to a shell of a grinding mill for ore grinding. The lifter bar has a volume which is 30-200 litres, preferably 50-100 litres, most preferably 60-90 litres. The lifter bar has an outer surface comprising a fixing surface to be arranged against the shell and a wear surface facing toward interior of the grinding mill. The lifter bars are mounted to the shell of the grinding mill from the fixing surface of the lifter bar while the opposing surface of the lifter bar is facing toward the interior of the grinding mill.

The lifter bars comprise a fixing element for mechanically connecting the lifter bar to the shell of the grinding mill. The fixing element is for example a mechanical fixing element which is connected to the body of the lifter bar on the side of the fixing surface and embedded therein such that it is used to affix the lifter bar to the inner surface of the shell of the grinding mill. The fixing element is a mechanical fixing element, for example a lifter channel or holes in the lifter bar such that bolts can be arranged through the holes and through the shell of the grinding mill to fasten the lifter bar to the shell. The lifter bars are mechanically fastened to the inner surface of the shell with fastening means such as a bolt connection through the lifter channel or through the holes. When the lifter bar is installed to the shell of the grinding mill the fixing surface of the lifter bar faces toward the inners surface of the shell of the grinding mill. The fixing element is made of any suitable metal and for example the lifter channel is made of aluminium or steel.

The lifter bar comprises a lifter bar body having a wear surface conforming the wear surface of the lifter bar and the lifter bar body comprises polyurethane. The lifter bar further comprises a reinforced wearing plate which comprises metal. The reinforced wearing plate is attached to the lifter bar body and forms part of the wear surface. The reinforced wearing plate further comprises a wearing surface for forming a part of the wear surface of the lifter bar and an attachment structure provided to the reinforced wearing plate for attaching the reinforced wearing plate to the lifter bar body. The attachment structure protrudes into the lifter bar body for forming a connection with polyurethane. The reinforced wearing plate is arranged at least partly on the outer surface of the lifter bar.

There may be provided a lifter bar mountable to a shell of a grinding mill for ore grinding, said lifter bar having an outer surface comprising a fixing surface to be arranged against the shell and a wear surface facing toward interior of the grinding mill. The lifter bar comprises a lifter bar body having a wear surface conforming the wear surface of the lifter bar the lifter bar body comprises polyurethane. The lifter bar further comprises a reinforced wearing plate attached to the lifter bar body and forming part of the wear surface, the reinforced wearing plate comprises metal, said reinforced wearing plate further comprises a wearing surface for forming a part of the wear surface of the lifter bar; and an attachment structure provided to the reinforced wearing plate for attaching the reinforced wearing plate to the lifter bar body, said attachment structure protruding into the lifter bar body for forming a connection with polyurethane.

The lifter bar is used in grinding mills for ore grinding such that multiple lifter bars are arranged to the shell of the grinding mill. The lifter bars comprise a lifter bar body comprising polyurethane and a reinforced wearing plate attached to the lifter bar body. The reinforced wearing plate comprises a wearing surface forming a part of an outer surface of the lifter bar and an attachment structure provided to the reinforced wearing plate and attaching the reinforced wearing plate to the lifter bar body. The attachment structure protrudes into the lifter bar body. The grinding mills' grinding energy per ton of ore is 1-30 kWh/t and preferably 3-20 kWh/t. The diameter of the grinding mill is 1-15 m, and most typically 1.5-10 m. The length of the grinding mill in horizontal direction is between 1 and 15 meter, and most typically from 2 to 8 m. Thickness of the shell of the grinding mill is 0.5-10 cm. Grinding mills can be for example SAG mills, AG mills, Ball mills, rod mills, scrubbers or regrinds.

The lifter bars as described earlier are assembled to the shell of the grinding mill by attaching the lifter bar to the shell of the grinding mill by arranging the fixing element against the shell and fastening the lifter bar to the shell with fastening means through the fixing element.

Lifter bars are made according to a method comprising the steps of providing a reinforced wearing plate comprising a wearing surface and an attachment structure for mechanically engaging with polyurethane in a lifter bar body comprising polyurethane, arranging the reinforced wearing plate in a mould such that the wearing surface forms at least part of the outer surface of the moulded lifter bar and adding polyurethane into the mould for forming the lifter bar body comprising polyurethane, the polyurethane being in such a state that it is arranged to react in the mould and form a connection with the reinforced wearing plate. Lifter bars can be made with moulds made of sheet metal having a thickness of less than 10 mm, preferably less than 5 mm and most preferably 0.2-2 mm.

The polyurethane in the context of this application means polyurethane material that may comprise additives, such as metal particles, ceramics or carbide. The polyurethane material comprises at least 50% and preferably at least 80% pure polyurethane the rest being additives and possible impurities.

In one embodiment a lifter bar is provided having a lifter bar body completely made of polyurethane and having a reinforced wear plate attached to the lifter bar body in the wear surface in which wear is most efficient.

In another embodiment the lifter bar or the lifter bar body comprises at least 35% polyurethane and the rest of the lifter bar body is rubber or other polyurethane material having different properties than the polyurethane forming at least 35% of the lifter bar.

In one embodiment the lifter bar body comprises rubber.

In the embodiment of the lifter bar which the lifter bar body comprises rubber the fixing element for mechanically connecting the lifter bar to the shell of the grinding mill is arranged such that it is embedded at least partly to the rubber. In other words the fixing element is connected to rubber in the body of the lifter bar on the side of the fixing surface and embedded therein. So the material of the lifter bar body around the fixing element is rubber. In other words the lifter bar comprises a reinforced wearing plate attached to the lifter bar body and forming part of the wear surface, the reinforced wearing plate comprises metal, said reinforced wearing plate further comprises a wearing surface for forming a part of the wear surface of the lifter bar; and an attachment structure provided to the reinforced wearing plate for attaching the reinforced wearing plate to the lifter bar body, said attachment structure protruding into the lifter bar body for forming a connection with polyurethane and the lifter bars comprise a fixing element for mechanically connecting the lifter bar to the shell of the grinding mill, said fixing element is forming a connection with rubber in the lifter bar body. The lifter bar body comprises polyurethane and rubber which form together a continuous lifter bar body. According to one embodiment the lifter bar body comprises polyurethane 85% at most and the lifter bar body further comprises rubber.

In a method for making a lifter bar the method comprises a step for adding rubber into the mould for forming the lifter bar body comprising rubber and polyurethane. The rubber and/or the polyurethane is in such a state that the connection between the rubber and the polyurethane is achieved.

In one embodiment the lifter bar body comprises another polyurethane having different properties than the polyurethane forming connection with the attachment structure. In one embodiment the lifter bar body further comprises the polyurethane forming the connection with the attachment 85% at most.

In one embodiment the lifter bar body is made of polyurethane.

A method for making a lifter bar as described above comprises providing a reinforced wearing plate comprising a wearing surface and an attachment structure for mechanically engaging with polyurethane in a lifter bar body comprising polyurethane and arranging the reinforced wearing plate in a mould such that the wearing surface forms at least part of the outer surface of the moulded lifter bar. The method further comprises adding polyurethane into the mould for forming the lifter bar body comprising polyurethane, the polyurethane being in such a state that it is arranged to react in the mould and form a connection with the reinforced wearing plate.

In one embodiment the method further comprises providing a mould made of sheet metal having a thickness of less than 10 mm, preferably less than 5 mm and most preferably 0.2-2 mm.

A method for assembling a lifter bar, comprising a fixing element for connecting the lifter bar to the shell, the fixing element is connected to the lifter bar body and arranged in the fixing surface as described, to a shell of a grinding mill comprises attaching the lifter bar to the shell of the grinding mill by arranging the fixing element against the shell and fastening the lifter bar to the shell with fastening means through the fixing element.

In one embodiment the fixing element is a lifter channel.

In one embodiment the method further comprises arranging lifting hooks to the wearing surface and moving the lifter bar against the shell by using the lifting hooks.

A grinding mill for ore grinding comprises multiple lifter bars The lifter bars are arranged to a shell of the grinding mill, said lifter bars comprising a lifter bar body comprising polyurethane and a reinforced wearing plate attached to the lifter bar body, the reinforced wearing plate comprising a wearing surface forming a part of an outer surface of the lifter bar; and an attachment structure provided to the reinforced wearing plate and attaching the reinforced wearing plate to the lifter bar body, said attachment structure protruding into the lifter bar body.

In one embodiment of the grinding mill the grinding energy per ton of ore of the grinding mill is 1-30 kWh/t and preferably 3-20 kWh/t.

In one embodiment of the grinding mill the grinding mill has a diameter of 1-15 m, preferably 1.5-10 m.

In one embodiment of the grinding mill the grinding mill has a length of 1-15 m in horizontal direction, preferably 2-8 m.

In one embodiment of the grinding mill the shell of the grinding mill having a thickness of 0.5-10 cm.

In one embodiment of the grinding mill the shell is rotatable in a predetermined direction.

In one embodiment the grinding mill is arranged to grind input material of which at least 80% has particle size between 0.1-300 mm, preferably 1-250 mm and most preferably 80-220 mm to grinded output material of which 80% has particle size between 0.02-3 mm, preferably 0.05-2.5 nm and most preferably 0.2-2 m.

Effect of the aforementioned lifter bar is that the reinforced wearing plate comprising metal makes a tighter connection with the lifter bar body comprising polyurethane than with other conventional lifter bar materials. Effect of the lifter bar having a reinforced wearing plate attached to the lifter bar body comprising polyurethane is that there is low energy consumption when manufacturing lifter bars having tight connection of reinforced wearing surface to the lifter bar.

### BRIEF DESCRIPTION OF THE DRAWINGS

In the following the lifter bar will be described in greater detail by means of preferred embodiments with reference to the attached drawings, in which

FIG. 1 shows a grinding mill;

FIG. 2 shows a cross section of the grinding mill in FIG. 1;

FIG. 3 shows one embodiment of the lifter bar;

FIG. 4 shows another embodiment of the lifter bar; and

FIG. 5 shows still another embodiment of the lifter bar.

### DETAILED DESCRIPTION OF THE

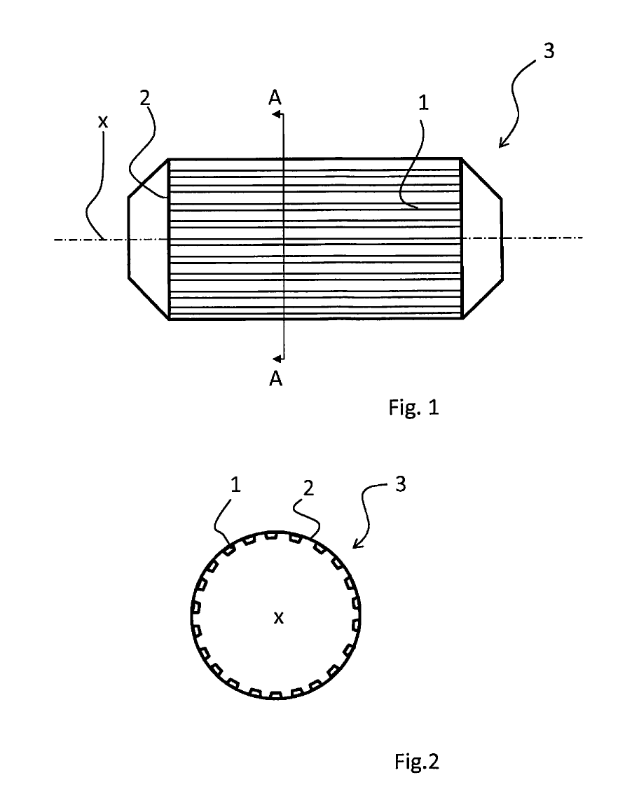

FIG. 1 shows, as already described earlier, that the solid material is grinded in a drum shaped shell 2 mounted for rotation about its central axis in the grinding mill 3. The axis of the rotatable shell 2 is generally horizontally arranged or slightly inclined towards one end in the grinding mill 3. The interior of the shell 2 forms a treatment chamber and has a cylindrical wall. The inner surface of the chamber is plated with a lining for protecting the shell 2 because the material to be processed is fed to the treatment chamber and grinding it causes wear in the chamber. The interior wall of the shell 2 is equipped with lifter bars 1 for lifting the material inside the shell 2 along the rotation so that as the shell 2 rotates the lifter bars 1 lift up the solid material along the inside wall of the shell 2 to a point where gravity causes the solid material to fall down inside the shell 2 and by falling down the solid material is crushed. A line of lifter 1 bars extend from one end of the drum to another and they are arranged in a short spacing adjacently along the cylindrical wall of the shell 2 such that there are shell plates arranged between adjacent lifter bars 1. As compared to the shell plates the lifter bars 1 protrude more from the shell 2 wall than the shell plates.

In other words FIG. 1 shows a longitudinal cross-section of a horizontal grinding mill 3 having an inner shell 2 comprising a cylindrical wall which the shell 2 comprises lifter bars 1 mounted to the cylindrical wall of the shell 2. The grinding mill 3 rotates about its central axis x in a predetermined direction. The axis of the shell 2 is horizontally disposed or slightly inclined toward the other end of the shell2. The surface of the inner shell 2 is plated with a lining such as shell plates, wear plates or similar elements for protecting the drum against wear caused by grinding. The shell plates are attached between the lifter bars 1 such that the lifter bars 1 and the shell plates together protect the surface of the inner shell 2 of the grinding mill 3.

FIG. 2 shows a cross-section of the grinding mill 3 shown in FIG. 1 taken along line A-A. The grinding mill 3 rotates in a predetermined direction around its axis indicated by x. The lifter bars 1 are arranged such that they are mounted to the shell 2 of the grinding mill 3 extending in the longitudinal direction of the horizontally arranged grinding mill. The lifter bar 1 comprises a mechanical fixing element, such as channel, a profile or an insert element in the bottom of the lifter bar 1 for mechanically fixing the lifter bar 1 to the shell 2. The lifter bar 1 is secured to the shell 2 of the grinding mill 3 with fasteners such as bolts extending from the shell 2 of the grinding mill 3 to the channel, the profile or the insert element in the bottom of the lifter bar 1 securing the lifter bar 1 to the interior wall of the grinding mill 3.

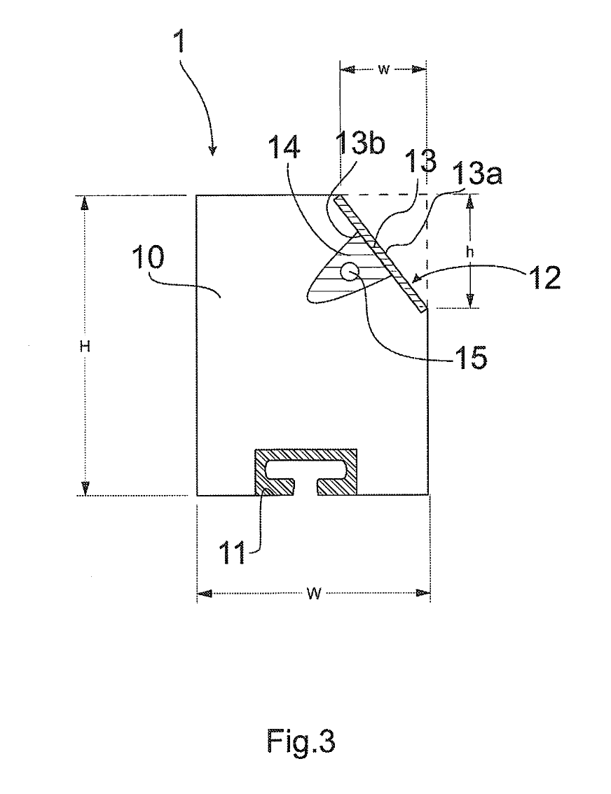

FIG. 3 shows one example of a lifter bar 1 as a cross-sectional view. The lifter bar 1 comprises a lifter bar body 10 having a fixing side for fixing the lifter bar 10 to the shell 2 of the grinding mill 3 (not shown in the figure) and a wear surface facing toward the interior of the grinding mill 3. The fixing side comprises a fixing surface which is the surface of the lifter bar 1 that is against the surface of the shell 2 of the grinding mill 3 when the lifter bar 1 is installed. The lifter bar 1 further comprises a reinforced wearing plate 12 attached to the lifter bar body 10 in the wear surface.

The lifter bar 1 further comprises a lifter channel 11 connected and embedded to the lifter bar body 10 in the fixing side such that the lifter channel forms part of the fixing surface of the lifter bar 1. Through the lifter channel 11 the lifter bar 1 is mounted to the inner surface of the shell 2 of the grinding mill 3 with fastening means.

The lifter bar 1 can be imaginarily divided into the fixing side and the wear side such that the part of the lifter bar 1 comprising the lifter channel 11 for attaching the lifter bar 1 to the shell 2 of the grinding mill 3 is the fixing side and the other part of the lifter bar 1 comprising the reinforced wearing plate 12 is the wear side. The fixing side forms at least 20% of the lifter bar 1 and the wear side forms at least 50% of the lifter bar 1. The lifter bar body 10 comprises polyurethane (PU) and the reinforced wearing plate 12 comprises metal. The lifter bar body 10 forms the biggest part of the lifter bar 1.

The lifter bar 1 has length of 0.2-3 m and advantageously 0.5-1.5 m, width of 1 is 50-350 mm and advantageously 100-200 mm and height of 100-500 mm, advantageously 120-300 mm. Dimensions in the lifter bar 1 are such that the length defines the reach of the lifter bar 1 when installed to the grinding mill and extending in the longitudinal direction of the horizontally arranged grinding mill, the width defines the reach of the installed lifter bar 1 along the periphery of the shell of the grinding mill and the height defines the reach of the lifter bar 1 from the fixing surface of the lifter bar 1 to the opposing end of the lifter bar 1.

The lifter bar comprises the reinforced wearing plate 12 attached to the lifter bar body 10 in the wear side such that the wearing plate 12 forms part of the outer surface of the lifter bar 1. The reinforced wearing plate 12 comprises a wearing surface 13 for forming part of the outer surface of the lifter bar 1 and an attachment structure 14 provided to the reinforced wearing plate 12 for attaching the reinforced wearing plate 12 to the lifter bar body 10. The wearing surface 13 is formed as a flat plate-like structure and the attachment structure is a protrusion from the plate-like wearing surface 13. The wearing surface 13 has an outer surface 13a and an inner surface 13b. The outer surface 13a of the wearing surface 13 forms part of the outer surface of the lifter bar 1 together with the outer surface of the lifter bar body 10. The attachment structure 14 is attached to the inner surface 13b of the wearing surface 13 and protrudes from the inner surface 13b of the wearing surface 13 into the lifter bar body 10. The length of the attachment structure 14 is at least 1/3 of the width of the lifter bar 1 and said attachment structure is arranged to protrude into the lifter bar body 10 forming a tight connection with the lifter bar body.

In one embodiment the largest dimension of the attachment structure 14 is at least 1/3 of the smallest dimension forming a volume of the lifter bar body 10.

The attachment structure 14 engages mechanically with the lifter bar body 10 and therefore a preferable shape of the attachment structure 14 is annular or round arch like a clamp or a fixing ring comprising a hole 15 arranged to extend through the attachment structure 14. Therefore, in one embodiment the attachment structure 14 is a fixing ring comprising the hole 15 arranged to extend through the attachment structure 14. The through hole 15 in the attachment structure 14 is arranged in a direction same as the longitudinal direction of the lifter bar 1 when the reinforced wearing plate is connected to the lifter bar body 10 for achieving more durable connection with the lifter bar body 10. The attachment structure 14 has a width in the direction of the through hole 0.3-5 cm. In other words the attachment structure is made of a material having thickness of 0.3-5 cm. A plurality of attachment structures 14 are associated with the wearing surface 13 such that the attachment structures 14 are distributed along the length of the wearing surface 13. Both the wearing surface 13 and the attachment structure 14 are made of metal but they may be made of different metal. The wearing surface 13 is preferably made of weldable wear-resistant metal. The embodiment of the lifter bar 1 shown in FIG. 1 comprises a reinforced wearing plate 12 arranged in the lifter bar body 10 such that the wearing surface 13 of the reinforced wearing plate 12 and the side of the lifter bar 1 which is in a vertical position form an angle relative to each other. In other words in the wear surface one corner of the lifter bar 1 is replaced with the wearing surface 13 of the reinforced wearing plate 12 such that the wearing surface 13 is slanted placed relative to the adjacent surfaces of the lifter bar body 10.

In one embodiment the wearing surface 13 and the attachment structure 14 are made of same material.

The lifter bar 1 has a predetermined length and the wearing surface 13 extends at least 50%, preferably 90%, most preferably 95% along the predetermined length of the lifter bar 1. The length defines the reach of the lifter bar 1 when installed to the grinding mill and extending in the longitudinal direction of the horizontally arranged grinding mill.

The length of the wearing surface being at least 50% of the predetermined length of the lifter bar 1 increases the durability of the lifter bar 1, and the length of 90% or more increases it significantly. The effect of polyurethane is that the connection between the reinforced wearing plate 12 having a length of 50% or more of the predetermined length of the lifter bar 1 is tight whatever the length is.

The wearing surface 13 has a thickness between 1 mm to 50 mm, preferably between 5 mm to 40 mm, most preferably between 10 mm to 30 mm. This kind of thickness protects the polyurethane such that the durability of the lifter bar 1 increases.

The lifter bar 1 has a predetermined height H and the wearing surface 13 extends at least 15%, preferably between 15% to 85% from the predetermined height H of the lifter bar 1, preferably between 25 to 75%. This dimension of the wearing surface 13 is shown with letter h in the figure.

The lifter bar 1 has a predetermined width W and the wearing surface 13 extends at least 1% of the predetermined width of the lifter bar 1, preferably between 1 to 100%, most preferably between 2.5 to 80%. This dimension of the wearing surface is shown with letter w in the figure.

The width W of the lifter bar 1 defines the reach of the installed lifter bar 1 along the periphery of the shell of the grinding mill and the height H of the lifter bar 1 defines the reach of the lifter bar 1 from the fixing surface of the lifter bar 1 to the opposing end of the lifter bar 1.

The size of the reinforced wearing plate 12 may vary provided that the connection with polyurethane can be achieved. The reinforced wearing plate 12 is arranged in every embodiment such that it is at least partly arranged on the side of the lifter bar 1 which faces toward the direction of the rotation of the grinding mill.

In a preferred embodiment of the lifter bar 1 the height h of the wearing surface 13 is at least 15% from height H of lifter bar 1 and width w of wearing surface 13 is at least 1%, from width W of lifter bar 1.

In a preferred embodiment of the lifter bar 1 the height h of the wearing surface 13 is 15%-85% from height H of the lifter bar 1 and width w of the wearing surface is 1%-100%, from width W of the lifter bar 1.

The height h of the wearing surface 13 is measured from the side of the lifter bar 1 facing toward the direction of the rotation of the grinding mill.

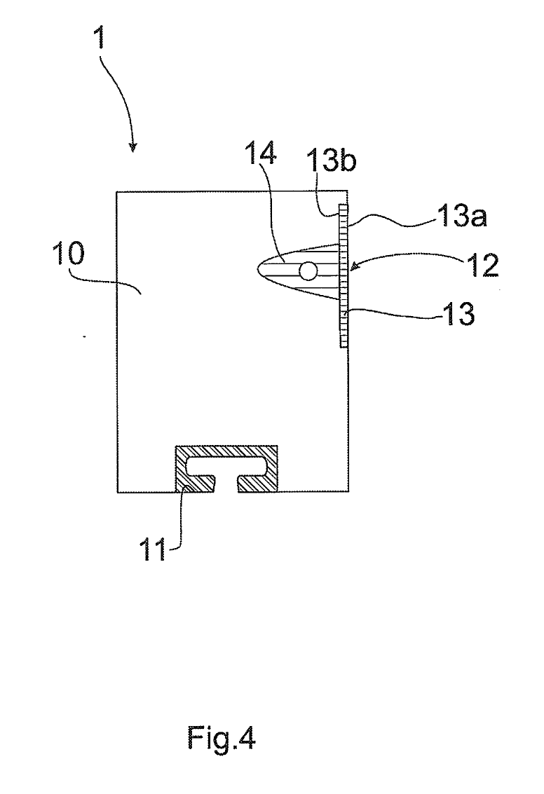

FIG. 4 shows another embodiment of the lifter bar 1 which comprises a lifter bar body 10 and the reinforced wearing plate 12 arranged to the lifter bar body 10 such that the wearing surface 13 is arranged on the side of the lifter bar 1 facing to an adjacent lifter bar 1 when installed in the grinding mill. The wearing plate 12 is arranged on that side of the lifter bar which lifts the ore to be grinded in the grinding mill so the side depends on the direction of the rotation of the grinding mill. The reinforced wearing plate 12 is arranged such that the wearing surface 13 does not reach the top side of the lifter bar 1 facing toward a middle point of the grinding mill.

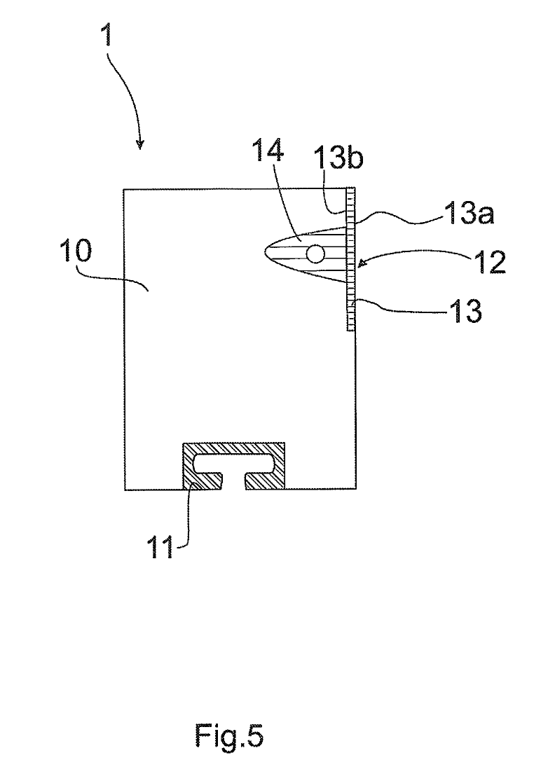

FIG. 5 shows another embodiment of the lifter bar 1 which comprises a lifter bar body 10 and the reinforced wearing plate 12 arranged to the lifter bar body 10 such that the wearing surface 13 is arranged on the side of the lifter bar 1 facing to an adjacent lifter bar 1 when installed in the grinding mill. The wearing plate 12 is arranged on that side of the lifter bar which lifts the ore to be grinded in the grinding mill so the side depends on the direction of the rotation of the grinding mill. The reinforced wearing plate 12 is arranged such that the wearing surface 13 extends to a junction point of the top side of the lifter bar 1 facing toward a middle point of the grinding mill and the side surface such that the thickness of the wearing surface 13 forms part of the top surface of the lifter bar 1.

In an embodiment of the lifter bar 1 the attachment structure 14 is arranged to protrude inside the lifter bar body 10 such that the attachment structure 14 is throughout embedded in the lifter bar body 10.

It will be obvious to a person skilled in the art that, as the technology advances, the inventive concept can be implemented in various ways. The invention and its embodiments are not limited to the examples described above but may vary within the scope of the claims.

1. A lifter bar, the lifter bar being mountable to a shell of a grinding mill for ore grinding, said lifter bar having an outer surface comprising a fixing surface to be arranged against the shell and a wear surface facing toward interior of the grinding mill, the lifter bar comprises:
a lifter bar body having a wear surface conforming the wear surface of the lifter bar, the lifter bar body comprises polyurethane (PU) and said lifter bar body further comprises rubber; and
a reinforced wearing plate attached to the lifter bar body and forming part of the wear surface, the reinforced wearing plate comprises metal, said reinforced wearing plate further comprises a wearing surface for forming a part of the wear surface of the lifter bar; and an attachment structure provided to the reinforced wearing plate for attaching the reinforced wearing plate to the lifter bar body, said attachment structure protruding into the lifter bar body for forming a connection with polyurethane (PU) and the lifter bar body comprising at most 85% polyurethane.

2. A lifter bar according to claim 1, wherein the lifter bar body comprises at least 35% polyurethane (PU).

3. A lifter bar according to claim 1, wherein the wearing surface is made of weldable wear-resistant metal.

4. A lifter bar according to claim 1, wherein the lifter bar has a predetermined length and that the wearing surface-extends at least 50%, preferably 90%, most preferably 95% along the predetermined length of the lifter bar.

5. A lifter bar according to claim 1, wherein the wearing surface has a thickness between 1 mm to 50 mm, preferably between 5 mm to 40 mm, most preferably between 10 mm to 30 mm.

6. A lifter bar according to claim 1, wherein the lifter bar has a predetermined height and the wearing surface extends at least 15%, preferably between 15 to 85% of the predetermined height of the lifter bar, preferably between 25 to 75%.

7. A lifter bar according to claim 1, wherein the lifter bar has a predetermined width and the wearing surface extends at least 1% of the predetermined width of the lifter bar, preferably between 1 to 100%, most preferably between 2.5 to 80%.

8. A lifter bar according to claim 1, wherein the attachment structure is arranged to protrude inside the lifter bar body such that the attachment structure is embedded in the lifter bar body.

9. A lifter bar according to claim 1, wherein the largest dimension of the attachment structure is at least 1/3 of the smallest dimension forming a volume of the lifter bar body.

10. A lifter bar according to claim 1, wherein the attachment structure is a fixing ring comprising a hole arranged to extend through the attachment structure.

11. A lifter bar according to claim 1, wherein the wearing surface and the attachment structure are made of same material.

12. A lifter bar according to claim 1, wherein the lifter bar further comprises a fixing element which is a mechanical fixing element.

13. A lifter bar according to claim 1, wherein the lifter bar further comprises a fixing element which is a lifter channel connected to the lifter bar body and arranged in the fixing surface.

14. A lifter bar according to claim 1, wherein the lifter bar having a length of 0.2-3 m and advantageously 0.5-1.5 m, a width of 50-350 mm and advantageously 100-200 mm and a height of 100-500 mm, advantageously 120-300 mm.

15. A lifter bar according to claim 1, wherein the attachment structure having a through hole arranged in a direction same as the longitudinal direction of the lifter bar.

16. A lifter bar according to claim 15, wherein the attachment structure having a width in the direction of the through hole of 0.3-5 cm.

17. (canceled)

18. A lifter bar according to claim 1, wherein the lifter bar body further comprises another polyurethane having different properties than the polyurethane (PU) forming connection with the attachment structure.

19. (canceled)

20. (canceled)

21. (canceled)

22. Method for making a lifter bar according to claim 1, the method comprising the steps of:
providing a reinforced wearing plate comprising a wearing surface and an attachment structure for mechanically engaging with polyurethane in a lifter bar body comprising polyurethane;
arranging the reinforced wearing plate in a mould such that the wearing surface forms at least part of the outer surface of the moulded lifter bar and the attachment structure protruding into the lifter bar body; and
adding polyurethane into the mould for forming the lifter bar body comprising polyurethane, the polyurethane being in such a state that it is arranged to react in the mould and form a connection with the reinforced wearing plate.

23. Method according to claim 22, wherein the method further comprises a step of:
providing a mould made of sheet metal having a thickness of less than 10 mm, preferably less than 5 mm and most preferably 0.2-2 mm.

24. Method for assembling a lifter bar according to claim 1 to a shell of a grinding mill, the lifter bar is such that said lifter bar having an outer surface comprising a fixing surface to be arranged against the shell and a wear surface facing toward interior of the grinding mill, the lifter bar comprising a lifter bar body having a wear surface and a reinforced wearing plate attached to the lifter bar body and forming part of the wear surface, said reinforced wearing plate comprises an attachment structure provided to the reinforced wearing plate for attaching the reinforced wearing plate to the lifter bar body, said attachment structure protruding into the lifter bar body for forming a connection with polyurethane (PU), said lifter bar body comprising at most 85% polyurethane and said lifter bar body further comprising rubber, the lifter bar further comprising a fixing element for connecting the lifter bar to the shell, the fixing element is connected to the lifter bar body and arranged in the fixing surface, the method comprising the steps of:
attaching the lifter bar to the shell of the grinding mill by arranging the fixing element against the shell; and
fastening the lifter bar to the shell with fastening means through the fixing element.

25. Method according to claim 24, wherein the fixing element is a lifter channel.

26. Method according to claim 24, wherein the method further comprising the steps of:
arranging lifting hooks to the wearing surface; and
moving the lifter bar against the shell by using the lifting hooks.

27. A grinding mill comprising multiple lifter bars for ore grinding, said lifter bars being arranged to a shell of the grinding mill, said lifter bars comprising a lifter bar body comprising polyurethane and said lifter bar body further comprising rubber, and a reinforced wearing plate attached to the lifter bar body, the reinforced wearing plate comprising a wearing surface forming a part of an outer surface of the lifter bar; and an attachment structure provided to the reinforced wearing plate and attaching the reinforced wearing plate to the lifter bar body, said attachment structure protruding into the lifter bar body for forming a connection with polyurethane (PU) and the lifter bar body comprising at most 85% polyurethane.

28. A grinding mill according to claim 27, wherein the grinding energy per ton of ore of the grinding mill 1-30 kWh/t and preferably 3-20 kWh/t.

29. A grinding mill according to claim 27, wherein the grinding mill having a diameter of 1-15 m, preferably 1.5-10 m.

30. A grinding mill according to any of claim 27, wherein the grinding mill having a length of 1-15 m in horizontal direction, preferably 2-8 m.

31. A grinding mill according to any of claim 27, wherein the shell of the grinding mill having a thickness of 0.5-10 cm.

32. A grinding mill according to any of claim 27, wherein the shell is rotatable in a predetermined direction.

33. A grinding mill according to any of claim 27, wherein said grinding mill is arranged to grind input material of which at least 80% has particle size between 0.1-300 mm, preferably 1-250 mm and most preferably 80-220 mm to grinded output material of which 80% has particle size between 0.02-3 mm, preferably 0.05-2.5 mm and most preferably 0.2-2 mm.
